(19) United States
(12) Patent Application Publication
(10) Pub. No.: US 2025/0053624 A1
(43) Pub. Date: Feb. 13, 2025

(54) INFORMATION PROCESSING DEVICE, INFORMATION PROCESSING METHOD, AND COMPUTER PROGRAM PRODUCT

(71) Applicant: SONY GROUP CORPORATION, TOKYO (JP)

(72) Inventor: RYOTARO SHIRAI, TOKYO (JP)

(21) Appl. No.: 18/719,509

(22) PCT Filed: Dec. 12, 2022
(86) PCT No.: PCT/JP2022/045720

§ 371 Date: Jun. 13, 2024

(30) Foreign Application Priority Data
Dec. 22, 2021 (JP) 2021-208015

(51) Int. Cl. G06F 21/31

(52) U.S. Cl. CPC G06F 21/31

(57) ABSTRACT

An information processing device (100) according to the present disclosure includes: a reception unit (133) that receives a request regarding provision of user information that is information collected from a user, the request being for a plurality of pieces of user information collected from a plurality of users; and a verification unit (134) that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.

### FIELD

The present disclosure relates to an information processing device, an information processing method, and a computer program product. Specifically, the present disclosure relates to management processing of consent information using a blockchain.

### BACKGROUND

In recent years, blockchains have been actively used in information processing. The blockchain is resistant to falsification of data due to its mechanism, and having excellent data traceability because a processing history remains.

As a technique using a blockchain, for example, there has been proposed a technique for preventing contents including personal information of a user from being output to the outside without permission without user's recognition.

### CITATION LIST

### Patent Literature

Patent Literature 1: JP 2020-71810 A

### SUMMARY

### Technical Problem

According to the related art, it is possible to prevent a content from being output without a consent of a user by writing whether or not consent information has been obtained from the user in a blockchain.

Meanwhile, in recent years, in order to utilize big data accumulated from a large number of users, there may occur a situation where consents are requested from a large number of users regarding data of each individual included in the big data. Under such circumstances, it is desirable that information is concealed, such as whether or not each person has consented to use the information. However, since a processing history usually remains in the blockchain, there is a concern that whether or not each person has consented to use the information may be leaked to a third party. In addition, when a data amount increases, there also occurs a problem that a processing load for verifying that a consent has been obtained from each user increases.

Therefore, the present disclosure proposes an information processing device, an information processing method, and a computer program product which enable information to be quickly utilized without disclosing whether or not a user has consented to use personal information.

### Solution to Problem

An information processing device according to one embodiment of the present disclosure includes a reception unit that receives a request regarding provision of user information that is information collected from a user, the request being for a plurality of pieces of user information collected from a plurality of users, and a verification unit that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.

### BRIEF DESCRIPTION OF DRAWINGS

FIG. 1 is a diagram illustrating a configuration example of an information processing system according to an embodiment.

FIG. 2 is a diagram illustrating an overview of information processing according to the embodiment.

FIG. 3 is a diagram illustrating a configuration example of a management system according to the embodiment.

FIG. 4 is a diagram illustrating an example of a consent information storage unit according to the embodiment.

FIG. 5 is a diagram for explaining verification processing according to the embodiment.

FIG. 6 is a flowchart (1) illustrating a procedure of the information processing according to the embodiment.

FIG. 7 is a flowchart (2) illustrating a procedure of the information processing according to the embodiment.

FIG. 8 is a diagram (1) for explaining verification processing according to a modification.

FIG. 9 is a diagram (2) for explaining verification processing according to a modification.

FIG. 10 is a diagram (1) illustrating an application example of the information processing according to the present disclosure.

FIG. 11 is a diagram (2) illustrating an application example of the information processing according to the present disclosure.

FIG. 12 is a hardware configuration diagram illustrating an example of a computer that implements functions of an information processing device.

### DESCRIPTION OF EMBODIMENTS

In the following, embodiments of the present disclosure will be described in detail with reference to the drawings. In each of the following embodiments, the same parts are denoted by the same reference numerals to omit redundant description.

The present disclosure will be described according to the following order of items.
1. Embodiments
1-1. Configuration of information processing system according to embodiment
1-2. Overview of information processing according to embodiment
1-3. Configuration of management system according to embodiment
1-4. Procedure of information processing according to embodiment
1-5. Modification of embodiment
1-6. Application example of information processing according to embodiment
2. Other Embodiments
3. Effects of information processing device according to present disclosure
4. Hardware configuration

### 1. Embodiment

### 1-1. Configuration of Information Processing System According to Embodiment

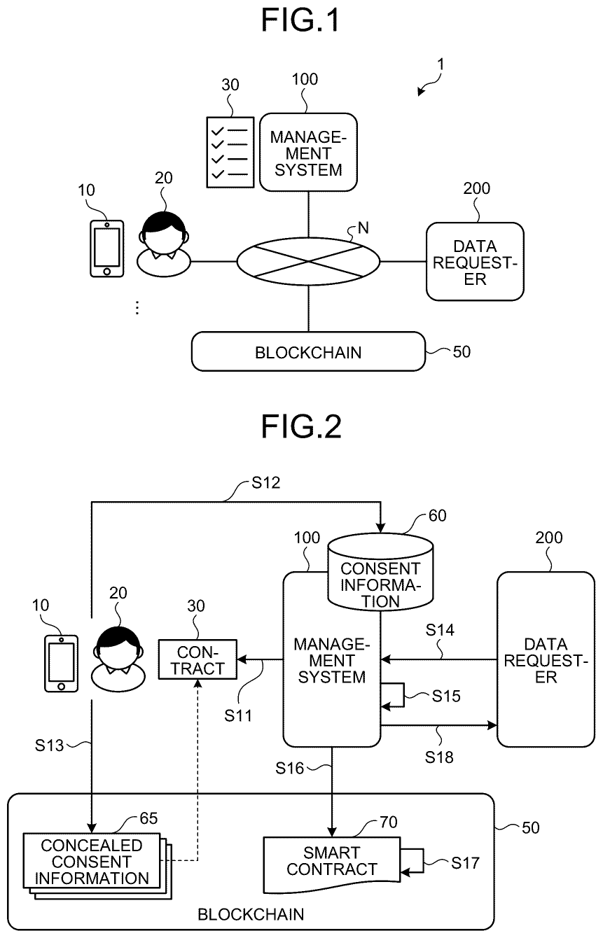

FIG. 1 is a diagram illustrating a configuration example of an information processing system 1 according to an embodiment. As illustrated in FIG. 1, the information processing system 1 includes a management system 100 that is an example of an information processing device according to the present disclosure. The management system 100 uses a blockchain 50 enabling registration and recording of information in an unfalsifiable manner, and executes processing for utilizing personal information (hereinafter, referred to as “user information”) collected from a user. For example, when sharing or providing user information with or to a third party who desires the user information, the management system 100 verifies that a consent regarding the provision of the user information is certainly obtained from a user who is a collection source of the user information, and provides the user information to the third party only when the consent is verified.

In the embodiment, the user information includes data or the like acquired by a terminal device (a smartphone, a wearable device, or the like) used by a user. As an example, the user information is action data (location information or the like), biological data (heart rate or the like), or the like of the user acquired by an application or the like installed in the terminal device in accordance with action of the user. A company that develops a product, a company that develops other application installed in a terminal device, or the like desires provision of such user information for the purpose of analyzing demands or the like.

Since user information includes personal information, as to provision to a third party, an agreement is usually made with a user in advance. In other words, the user can choose whether or not to consent to provide the user information collected from the user himself/herself to a third party.

However, in order to provide user information without any problem, it is desirable to satisfy the following requirements. First, since the fact that a user consents to provide user information to a third party (hereinafter referred to as “consent information”) should not be falsified, the fact needs to be recorded so as not to be falsified. Second, in order to protect personal information, it is necessary to record who the user is, what kind of information an individual user has consented to provide, or the like in a form invisible from the outside. Third, in order to guarantee transparency of sharing of user information, in providing the user information to a third party, the fact of having verified that the consent information has been correctly received from the user needs to be recorded in a form that can be seen by anyone contrary to the personal information.

Furthermore, high-speed verification processing is also an essential element for executing provision of user information. Specifically, as the number of users who use a terminal device or a predetermined application increases, it is estimated that processing of verifying consent information takes enormous time and effort. However, for example, in a case where a company desires a large amount of user information in order to utilize big data, when it takes an enormous amount of time to perform processing of verifying that a consent is obtained from each user while specifying each individual, the user information cannot be quickly provided, and as a result, the user information cannot be utilized. In other words, in utilization of a large amount of user information, there exists a problem of realizing high-speed verification processing while realizing appropriate management of the user information.

Therefore, the management system 100 according to the embodiment solves the above problem by using the blockchain 50 and realizing high-speed verification processing. In the following, each element constituting the information processing system 1 including the management system 100 will be described with reference to FIG. 1.

As illustrated in FIG. 1, the information processing system 1 includes a user terminal 10, the blockchain 50, the management system 100, and a data requester 200. These various devices are communicably connected in a wired or wireless manner via a network N (e.g., the Internet). Note that the number of devices included in the information processing system 1 illustrated in FIG. 1 is not limited to the illustrated number. For example, the information processing system 1 may include a plurality of the user terminals 10. Furthermore, each component in FIG. 1 conceptually illustrates a function in the information processing system 1, and various modes can be taken according to the embodiment. For example, the management system 100 may be one or two or more server devices, or may be a program operating in the server device.

The user terminal 10 is an information processing device used by a user 20. The user terminal 10 is, for example, an information processing device such as a smartphone, a desktop personal computer (PC), a notebook PC, a tablet terminal, or a wearable device.

In the example of FIG. 1, the user 20 is a person who provides the management system 100 with user information collected by use of the user terminal 10. For example, the user 20 is a person who uses service, an application, or the like provided by the management system 100, and provides the management system 100 with user information that may be generated at the time of use.

At this time, the user 20 consents to provide the user information to a third party according to a contract 30 which is an agreement regarding handling of the user information and issued by the management system 100. For example, in the contract 30, regarding use of a predetermined application, agreements such as “allowing a third party to share biometric data”, “allowing a third party to share location information”, and “allowing a third party to share age and gender” are described in a check list format. For example, at the time of installing the application, the user 20 checks the contract 30 displayed on the user terminal 10 to indicate an intention to consent to the provision of the user information to the third party. Specifically, the user 20 consents to provide the user information by browsing the check list of the contract 30 and checking the information that the user consents to provide to the third party.

Note that in the present specification, the “user” may mean “the user terminal 10 used by the user”. For example, “the user 20 transmits the consent information” may actually mean that “the user terminal 10 used by the user 20 transmits the consent information”.

The blockchain 50 refers to a distributed ledger system in which data is shared by a plurality of participants (nodes) connected to a network. In the example of FIG. 1, the blockchain 50 is, for example, a private blockchain managed by the management system 100. Note that various known techniques may be used for various types of processing in the blockchain 50 described below (such as processing of registering in the blockchain 50 and verification processing).

The management system 100 is an example of the information processing device according to the present disclosure, and executes information processing according to the present disclosure. Specifically, the management system 100 manages the consent information acquired from the user 20 via the contract 30 and provides the user information to the data requester 200.

The data requester 200 is a person who requests provision of the user information, and is, for example, a company or the like that utilizes or manages the user information. Note that in the present disclosure, the data requester 200 may mean a terminal device or a server used by a company or the like.

### 1-2. Overview of Information Processing According to Embodiment

Next, information processing executed in the information processing system 1 will be described with reference to FIG. 2. FIG. 2 is a diagram illustrating an overview of the information processing according to the embodiment.

As illustrated in FIG. 2, the management system 100 transmits the contract 30 to the user 20 (Step S11). In the contract 30, for example, regarding use of a predetermined application, agreements such as “allowing a third party to share biometric data”, “allowing a third party to share location information”, and “allowing a third party to share age and gender” are described in the check list format.

When trying to use a predetermined application, the user 20 first confirms a content of the contract 30, and chooses whether or not to consent to the provision of the user information to the third party. For example, the user 20 creates consent information indicating whether or not to consent to the provision of the user information by checking each check list of the contract 30 displayed on the user terminal 10. For example, an application for consent information creation that is provided from the management system 100 is installed in the user terminal 10, and the application creates the consent information according to operation of the user 20.

The user 20 transmits the created consent information to the management system 100 (Step S12). The management system 100 stores consent information 60 acquired from the user 20.

In addition to the processing of transmitting the created consent information 60 to the management system 100, the user 20 conceals the consent information 60 and registers the concealed consent information in the blockchain 50 (Step S13). The blockchain 50 registers and records concealed consent information 65.

The concealed consent information 65 includes information for identifying the user 20 and the consent information such as a content checked on the contract 30 by the user 20. For example, the user 20 conceals the consent information by a signature method by processing of an application or the like operating on the user terminal 10. Specifically, the user terminal 10 hashes the content (character information and the like) described in the contract 30, the content checked on the contract 30 by the user 20, and the like on the basis of the operation of the above-described application. Then, the user terminal 10 registers the hashed information in the blockchain 50. In other words, the user 20 can leave a trace of his/her consent information for the contract 30 in the blockchain 50. In this manner, by hashing the consent information, the consent information is registered in the blockchain 50 in a form that cannot be referred to from the outside.

Thereafter, the data requester 200 who desires user information requests the management system 100 to provide a plurality of pieces of user information (Step S14). As an example, it is assumed that the data requester 200 requests provision of user information of 100 users.

When such a request is made, the management system 100 creates a proof (also referred to as “proof data” or “Proof”) indicating that consents of 100 users who provide the user information are certainly obtained among a plurality of users who have made a contract according to the contract 30 (Step S15). Although details will be described later, the management system 100 creates a proof in a format enabling verification of consent information for 100 persons to be collectively processed.

Then, the management system 100 transmits the created proof to the blockchain 50 (Step S16). For example, the management system 100 creates a smart contract 70, which is a script for verifying that the consent information has been obtained on the blockchain 50 on the basis of the created proof, and causes the created smart contract 70 to operate on the blockchain 50 (Step S17).

In the blockchain 50, verification for the proof created by the management system 100 is executed. Then, in a case where the verification is executed, the blockchain 50 returns a verification result to the management system 100.

Upon acquiring the verification result, the management system 100 provides the data requester 200 with the user information of the 100 persons for whom the consent information has been verified (Step S18).

As described above, making use of the characteristics of the blockchain 50 in which the registered information cannot be falsified, the management system 100 according to the embodiment registers the consent information in the blockchain 50 to prevent the consent information from being falsified. Furthermore, by encrypting the information registered in the blockchain 50, the content of the consent information itself is registered in a form that cannot be referred to from the outside. On the other hand, the fact that the management system 100 has transmitted the proof to the blockchain 50 to perform verification and has verified that the consent information has been received from the user 20 can be referred to from the outside. As a result, according to the information processing system 1, it is possible to secure transparency of data sharing while maintaining confidentiality of the user information and the consent information.

Furthermore, when providing a plurality of pieces of user information, the management system 100 collectively verifies the consent information related to the user information. As a result, since the management system 100 can complete the verification at high speed, data provision can be performed quickly. As a result, the management system 100 makes it possible to utilize the user information at high speed without disclosing to the outside whether or not the user has consented to the use of the user information.

### 1-3. Configuration of Management System According to Embodiment

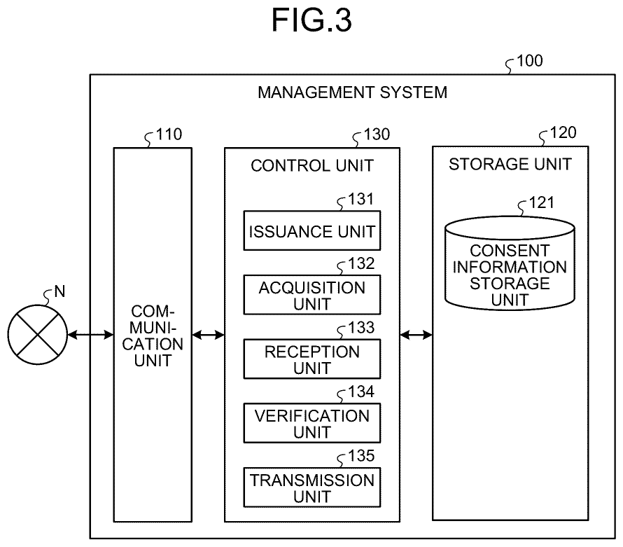

Next, a configuration of the management system 100 that executes the information processing according to the embodiment will be described. FIG. 3 is a diagram illustrating a configuration example of the management system 100 according to the embodiment.

As illustrated in FIG. 3, the management system 100 includes a communication unit 110, a storage unit 120, and a control unit 130. Note that the management system 100 may have an input unit (e.g., a keyboard, a mouse, or the like) that receives various operations from a manager or the like who manages the management system 100, and a display unit (e.g., a liquid crystal display or the like) for displaying various types of information.

The communication unit 110 is realized by, for example, a network interface controller, a network interface card (NIC), or the like. The communication unit 110 may be a universal serial bus (USB) interface including a USB host controller, a USB port, and the like. Furthermore, the communication unit 110 may be a wired interface or a wireless interface. For example, the communication unit 110 may be a wireless communication interface of a wireless LAN system or a cellular communication system. The communication unit 110 functions as a communication unit or a transmission unit of the management system 100. For example, the communication unit 110 is connected to the network N in a wired or wireless manner, and transmits and receives information to and from an external device such as the user terminal 10, the blockchain 50, or the data requester 200, an external network, or the like via the network N. The network N is realized by, for example, a wireless communication standard or system such as Bluetooth (registered trademark), the Internet, Wi-Fi (registered trademark), a ultra wide band (UWB), low power wide area (LPWA), and ELTRES (registered trademark).

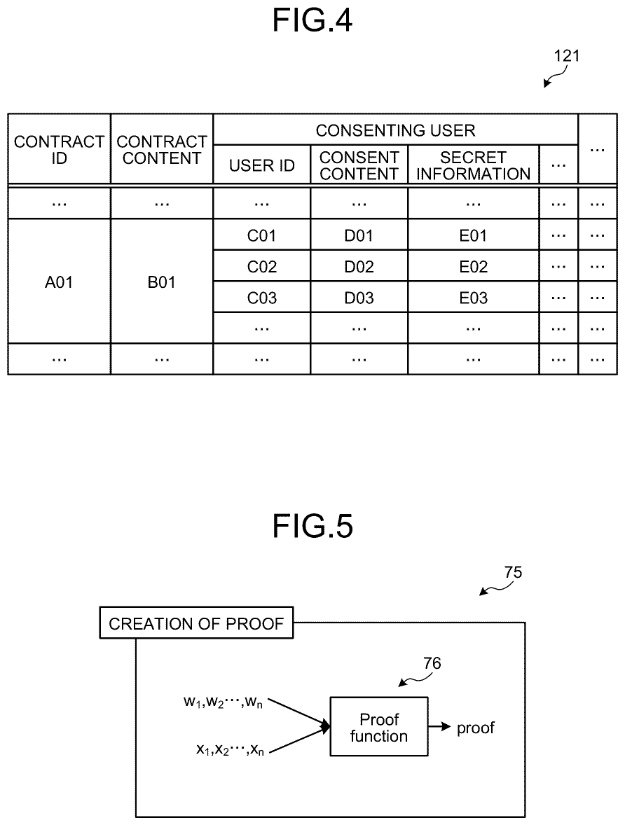

The storage unit 120 is realized by, for example, a semiconductor memory element such as a random access memory (RAM) or a flash memory, or a storage device such as a hard disk or an optical disk. The storage unit 120 according to the embodiment includes a consent information storage unit 121. The consent information storage unit 121 will be described below with reference to FIG. 4.

FIG. 4 is a diagram illustrating an example of the consent information storage unit 121 according to the embodiment. As illustrated in FIG. 4, the consent information storage unit 121 stores information regarding a user who has made the contract, consent information indicating that the user has consented to the contract, and the like. In the example illustrated in FIG. 4, the consent information storage unit 121 has items such as “contract ID”, “contract content”, “consenting user”, “user ID”, “consent content”, and “secret information”. Although in FIG. 4, the information stored in the storage unit 120 is conceptually illustrated as “A01”, each piece of information to be described later is stored in the storage unit 120 in practice.

The “contract ID” indicates identification information for identifying a contract. “Contract content” indicates a content described in the contract. For example, the contract content is an agreement regarding use of a predetermined application, such as “allowing sharing of biometric data with a third party” or “allowing sharing of location information with a third party”.

The “consenting user” indicates a user who has consented to the contract. The “user ID” indicates identification information for identifying a user. The “consent content” indicates the consent information indicating which item of the contract the user has consented to or has not consented to. The “secret information” indicates user information actually collected from a user. For example, the secret information may include user's action data, biometric data, user's age, address, and the like, personal information of each user, and the like.

Returning to FIG. 3, the description will be continued. The control unit 130 is realized by, for example, a central processing unit (CPU), a micro processing unit (MPU), a graphics processing unit (GPU), or the like executing a program (e.g., an information processing program according to the present disclosure) stored in the management system 100 using a random access memory (RAM) or the like as a work area. Furthermore, the control unit 130 is a controller, and may be realized by, for example, an integrated circuit such as an application specific integrated circuit (ASIC) or a field programmable gate array (FPGA).

As illustrated in FIG. 3, the control unit 130 has an issuance unit 131, an acquisition unit 132, a reception unit 133, a verification unit 134, and a transmission unit 135, and implements or executes a function and an action of information processing to be described below. Note that an internal configuration of the control unit 130 is not limited to the configuration illustrated in FIG. 3, and may be other configuration as long as information processing to be described later is performed.

The issuance unit 131 controls issuance of various types of information. Specifically, the issuance unit 131 issues a contract that defines handling of the user information.

For example, the issuance unit 131 issues a contract in which agreements such as “allowing arbitrary data to be shared with a third party” are arranged in the check list format. Note that the contract issued by the issuance unit 131 is not limited to this format, and may be in any format as long as a user can indicate a consent regarding sharing of the user information. The issuance unit 131 transmits the issued contract to the user terminal 10 via the network N.

The acquisition unit 132 acquires various types of information. For example, the acquisition unit 132 acquires the user information and the consent information from the user who has signed a contract issued by the issuance unit 131.

Specifically, the acquisition unit 132 acquires, as the user information, the identification information for specifying a user, action data, biometric data, and the like of the user collected via an application or a wearable device. Furthermore, in a case where a user consents, the acquisition unit 132 acquires personal information such as gender and an address of the user as the user information.

In addition, the acquisition unit 132 acquires consent information indicating that the user has consented to share the user information with a third party on the basis of the contract issued by the issuance unit 131. For example, the acquisition unit 132 acquires, for each user and for each contract, consent information indicating what user information the user has allowed to share with the third party or has not allowed to share with the third party.

The acquisition unit 132 appropriately stores the acquired information in the storage unit 120. Such information is managed by the management system 100 separately from the blockchain 50.

The reception unit 133 receives a request regarding provision of user information which is information collected from individual users, the request being for a plurality of pieces of user information collected from the plurality of users, respectively. Specifically, the reception unit 133 receives a request regarding provision of the user information from the data requester 200 who intends to utilize the user information.

In a case where the request is received by the reception unit 133, the verification unit 134 verifies consents of a plurality of users by executing a procedure for collectively proving that a consent has been obtained from each user who is a collection source of the plurality of pieces of user information on the blockchain 50 in which a trace indicating that the user has consented in advance to the provision of the user information to the third party is registered.

For example, the verification unit 134 verifies consents of a plurality of users by executing a procedure for proving that a secret value used in conversion processing for concealment has been acquired on the blockchain 50 in which a concealed trace is registered. More specifically, the verification unit 134 verifies the consents of the plurality of users on the blockchain 50 in which a trace of hashing for converting a contract and consent information regarding the contract into a hash value is registered. Note that concealment (encryption) is not limited to hashing on the basis of the signature method, and may be encryption processing by other reversible conversion methods. As described above, the verification unit 134 performs the verification process using the blockchain 50 in which an encrypted trace is registered, thereby securing both confidentiality of the user information and transparency of the verification.

In other words, when the user registers the consent information in the blockchain 50 as it is, the information in the blockchain 50 can be referred to from the outside, and thus “who consented with what” is disclosed. However, in the information processing of the present disclosure, by concealing the information to be registered in the blockchain 50 using the signature method, it is possible to prove that the user consents on the blockchain 50 while protecting the personal information.

By using, for example, a commitment having homomorphism (Pedersen commitment or the like) as a procedure for collectively proving the consent information of the plurality of users, the verification unit 134 verifies knowledge regarding a plurality of commitments by one proof calculation.

Such verification processing will be described with reference to FIG. 5. FIG. 5 is a diagram for explaining the verification processing according to the embodiment. An arithmetic image 75 illustrated in FIG. 5 schematically illustrates processing in which the verification unit 134 creates a proof.

In the arithmetic image 75, “wₙ” (n is an arbitrary natural number) indicates a secret value created by a user i (i is an arbitrary natural number). For example, the user issues a secret value when writing the consent information to the blockchain 50, and transmits the issued value to the management system 100 as the secret information. In other words, knowing the value of wₙ means that a consent is obtained from the user.

Furthermore, in the arithmetic image 75, “xₙ” indicates a public value to be written to the blockchain 50 by the user i. In other words, a person who knows “wₙ” can be said to be a person who can specify “xₙ”.

As described above, the collation between wₙ and xₙ is performed, whereby a proof (Proof) indicating that a consent is obtained from the user is created. However, for example, in a case where the management system 100 is requested to provide user information for 100 persons, it is necessary to perform 100 times of calculation. In order to quickly perform the verification processing, it is desirable that the number of such calculations be small.

Therefore, as illustrated in FIG. 5, the verification unit 134 puts together “w₁, w₂, . . . , wₙ”, puts together “x₁, x₂, . . . , xₙ”, and inputs them into an arbitrary proof expression 76 for collating them. Specifically, the verification unit 134 collates a collection of secret values set by arbitrary n users (e.g., a sum of secret values) with a collection of public values derived from the respective secret values (e.g., a sum of public values). Since the management system 100 manages all these values, it is possible to calculate a total value.

As described above, the verification unit 134 can collectively create a proof of consent information of a plurality of users by collating the collected values with the proof expression 76. Specifically, in a case of creating a proof of the consent information for 100 persons, the verification unit 134 collectively creates a proof of the consent information for 100 persons instead of creating 100 proofs of the respective users. Then, the verification unit 134 verifies the created proof on the blockchain 50, so that it can be verified that consents of 100 persons have been certainly obtained (i.e., that the proof is registered in the blockchain 50). As described above, the verification unit 134 can quickly perform the verification processing even in a case where the user information for an enormous number of people is requested.

The above verification processing is summarized as follows. Specifically, when the request for the provision of the user information for 100 persons is received by the reception unit 133, the verification unit 134 randomly extracts the user information for 100 persons from the held user information. Subsequently, the verification unit 134 specifies a user on the basis of information (user ID or the like) for identifying each user related to the extracted user information. Then, the verification unit 134 acquires a secret value issued when each user has registered in the blockchain 50, and creates a proof by collating a value obtained by collecting the acquired secret values of the plurality of users with a value obtained by collecting the public values written by the plurality of users in the blockchain 50. Specifically, the verification unit 134 creates a proof by collating a total value of the secret values acquired from the plurality of users with a total value of the public values written by the plurality of users in the blockchain 50. Furthermore, the verification unit 134 verifies consents of the plurality of users by verifying the proof on the blockchain 50. In other words, the verification unit 134 verifies the consents of the plurality of users by verifying that a trace is registered on the blockchain 50 using the smart contract that verifies a created proof on the blockchain 50. Specifically, the verification unit 134 acquires, from the blockchain 50, information indicating that it has been verified that the consents have been obtained from all the 100 persons.

Note that in the above processing, the example has been described in which the verification unit 134 creates a proof by a total of the secret values set by the plurality of users and a total of the public values, and verifies the proof on the blockchain 50. However, an algorithm for creating a proof is not limited thereto. Specifically, the verification unit 134 may create a proof using not only a total value but also a value derived by a different algorithm as long as it is a method of creating a proof using information that cannot be created without knowing all the secret information (w₁, w₂, w₃, . . . ).

The transmission unit 135 transmits various types of information. In a case where the verification unit 134 verifies consents of a plurality of users, the transmission unit 135 transmits user information related to the users whose consents have been verified to a request source. Specifically, the transmission unit 135 transmits the user information related to a request received by the reception unit 133 to the data requester 200 on the basis of the consent information verified by the verification unit 134.

### 1-4. Procedure of Information Processing According to Embodiment

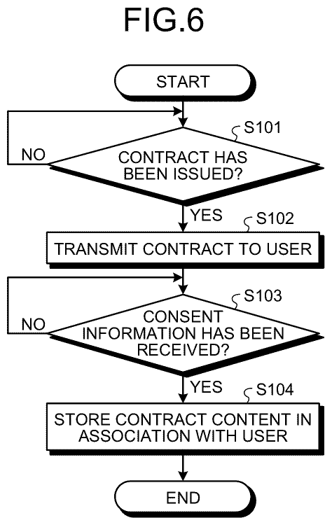

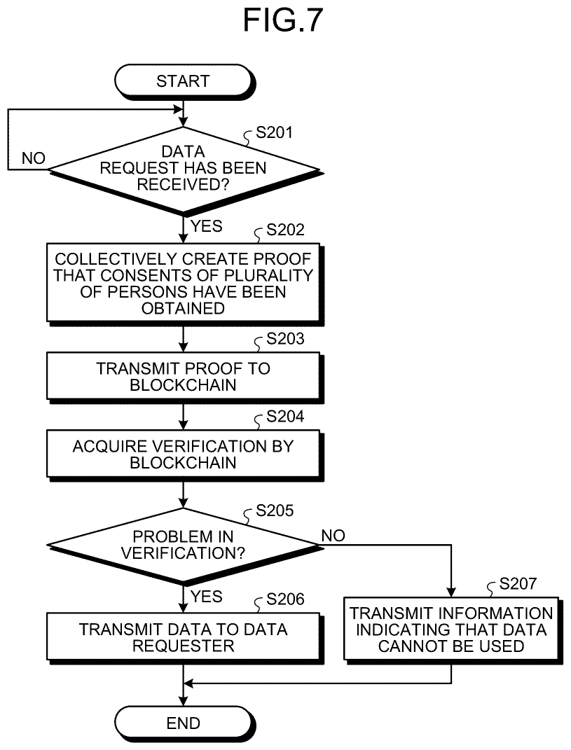

Next, a procedure of the information processing according to the embodiment will be described with reference to FIGS. 6 and 7. First, a flow of issuance processing according to the embodiment will be described with reference to FIG. 6. FIG. 6 is a flowchart (1) illustrating a procedure of the information processing according to the embodiment.

As illustrated in FIG. 6, the management system 100 determines whether or not a contract describing an agreement regarding provision of user information with a user has been issued (Step S101). In a case where the contract has not been issued (Step S101; No), the management system 100 waits until the contract is issued.

On the other hand, in a case where the contract has been issued (Step S101; Yes), the management system 100 transmits the issued contract to the user (Step S102).

Thereafter, the management system 100 determines whether or not consent information related to the contract has been received (acquired) from a user (Step S103). In a case where the consent information has not been received (Step S103; No), the management system 100 waits until the consent information is received.

On the other hand, in a case where the consent information has been received (Step S103; Yes), the management system 100 stores contract contents including the consent information and the like in the storage unit 120 in association with the user (Step S104).

Next, a flow of user information provision processing according to the embodiment will be described with reference to FIG. 7. FIG. 7 is a flowchart (2) illustrating a procedure of the information processing according to the embodiment.

As illustrated in FIG. 7, the management system 100 determines whether or not a request related to provision of data has been received from the data requester 200 (Step S201). In a case where the request has not been received (Step S201; No), the management system 100 waits until the request is received.

On the other hand, in a case where the request has been received (Step S201; Yes), the management system 100 collectively creates a proof that consents of a plurality of persons corresponding to the requested number of data have been obtained (Step S202). Then, the management system 100 transmits the created proof to the blockchain 50 (Step S203). Specifically, the management system 100 transmits, to the blockchain 50, a smart contract for verifying the created proof in the blockchain 50.

Thereafter, the management system 100 acquires information indicating that the proof has been verified by the blockchain 50 (Step S204).

The management system 100 determines whether there is no problem in the acquired verification (Step S205). If there is no problem in the verification (Step S205; Yes), the management system 100 transmits the data to the data requester 200 (Step S206). On the other hand, if any problem such as unsuccessful verification occurs (Step S205; No), the management system 100 transmits information indicating that a third party cannot use the data to the data requester 200 (Step S207).

### 1-5. Modification of Embodiment

### 1-5-1. First Modification of Verification Algorithm

In the above-described embodiment, the description has been made with respect to the processing in which the management system 100 collectively verifies consent information of a plurality of users by creating a proof on the basis of a sum of secrets values of a plurality of users. However, the management system 100 may verify consent information by a method other than the processing described in the embodiment.

For example, instead of verifying consents of a relatively large number of users as in the embodiment, the management system 100 may use a method suitable for a use case of obtaining a consent regarding one or a small number of users who are face-to-face.

For example, it is assumed that the management system 100 is requested by the data requester 200 to provide user information regarding a specific one user. In this case, the management system 100 needs to verify whether or not a consent has been obtained from this one user. However, when verification is performed on a specific one user, while a content of the information is concealed, it might be disclosed to which user the verification has been performed.

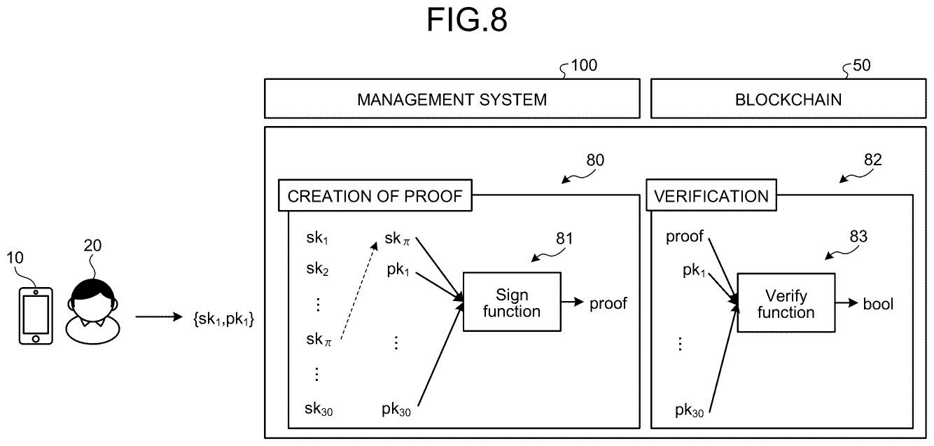

Therefore, in verification of a small number of users, the management system 100 can adopt a method of randomly mixing and grouping a plurality of users in addition to users actually requested to be verified, and creating a proof for the users in a lump. Such a method will be described with reference to FIG. 8. FIG. 8 is a diagram (1) for explaining verification processing according to a modification.

In FIG. 8, in a case where an arbitrary user 20 has consented to a contract, the user terminal 10 creates a pair of a secret key and a public key (sk₁, pk₁) indicating a consent. The user terminal 10 registers the public key in the blockchain 50 and transmits the private key to the management system 100.

An arithmetic image 80 illustrated in FIG. 8 schematically illustrates processing of creating a proof by the management system 100. In the arithmetic image 80, “sk₁, sk₂, . . . ” indicates each private key created by each user. Furthermore, in the arithmetic image 80, “pk₁, pk₂, . . . ” indicates each public key created by each user. Furthermore, in FIG. 8, a secret key of a user to be verified is assumed to be “sk_{π}”.

When creating a proof regarding a specific one user, the management system 100 collects information of a plurality of other users. In the example of FIG. 8, the management system 100 sets, as a target user, a group of k people (in the example of FIG. 8, k=30) together with unrelated users (k−1), and creates a proof for the group.

In this case, as illustrated in the arithmetic image 80, the management system 100 extracts secret keys “sk₁, sk₂, . . . , sk₃₀” of other 29 users randomly extracted in addition to the secret key “sk_{π}” of the target user. Then, the management system 100 creates a proof via a code function 81 that collates a pair of each private key and the public key. In this manner, the management system 100 creates a proof as a group, thereby enabling a proof to be created that prevents one target user from being specified. Specifically, the proof created at this time merely indicates that the management system 100 “knows a secret key of one of 30 users”, and is a proof that does not allow anyone to be identified among the 30 people. The management system 100 transmits the created proof to the blockchain 50.

As illustrated in an arithmetic image 82, verification regarding the proof transmitted from the management system 100 is performed in the blockchain 50. At this time, in the blockchain 50, it is verified whether the created proof and each secret key are correct or not via a verification expression 83 related to verification. Then, even in a case where such verification is processed, since the fact that “of the 30 traces, which was needed for the verification of consent confirmation (which was the private key created by the target user)” is concealed, the third party cannot refer to the processed verification on the blockchain 50. Then, the data requester 200 cannot confirm which user's information has been used for the verification.

As described above, in a case of performing verification related to a small number of users, the management system 100 creates a proof after grouping a plurality of users as described above, and thus, it is possible to prevent a user to be verified from being specified. In other words, the management system 100 can perform verification with higher safety.

### 1-5-2. Second Modification of Verification Algorithm

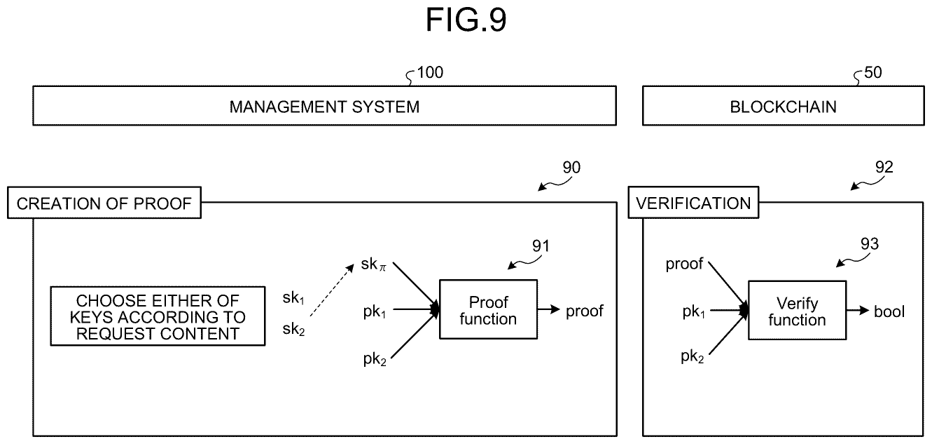

The management system 100 may perform verification by a further different method. In such a method, in a case where an arbitrary user 20 has consented to a contract, the user terminal 10 creates a dummy key pair together with a key pair indicating a true consent. Then, when creating a proof, the management system 100 uses a true secret key when the data requester 200 requests sharing regarding user information of a predetermined user, and uses a dummy secret key for the proof when the data requester does not request sharing. The management system 100 performs this process for all users participating in the system. Such a method will be described with reference to FIG. 9. FIG. 9 is a diagram (2) for explaining verification processing according to a modification.

In FIG. 9, in a case where an arbitrary user 20 has consented to a contract, the user terminal 10 creates a pair of keys (sk₁, pk₁) representing a true consent and a pair of dummy keys (sk₂, pk₂). The user terminal 10 registers the public key in the blockchain 50 and transmits the private key to the management system 100.

As illustrated in an arithmetic image 90, the management system 100 chooses either a true key or a dummy key according to a request content of the data requester 200. Then, the management system 100 creates a proof through a proof expression 91 using the chosen private key. In such a method, the management system 100 creates a proof for every user associated with a contract regardless of the number of pieces of requested data.

As illustrated in an arithmetic image 92, in the blockchain 50, verification regarding the proof transmitted from the management system 100 is performed. At this time, the blockchain 50 verifies whether all the created proofs are correct or not via a verification expression 93.

According to such a method, the blockchain 50 does not know which one of all traces on the blockchain 50 for a certain contract is necessary for consent confirmation. In addition, even if the data requester 200 knows a user who owns the data, the data requester 200 does not know which trace the user has created.

In this manner, the management system 100 performs verification including the processing of choosing a true key and a dummy key as described above, thereby preventing a user to be verified from being specified. In other words, the management system 100 can perform verification with higher safety.

Note that the management system 100 does not necessarily need to create proofs for all the users, and may create a predetermined number (e.g., a half of the whole.) of proofs that include a target user and make it difficult to specify the user. As a result, the management system 100 can speed up the verification processing.

### 1-6. Application Example of Information Processing According to Embodiment

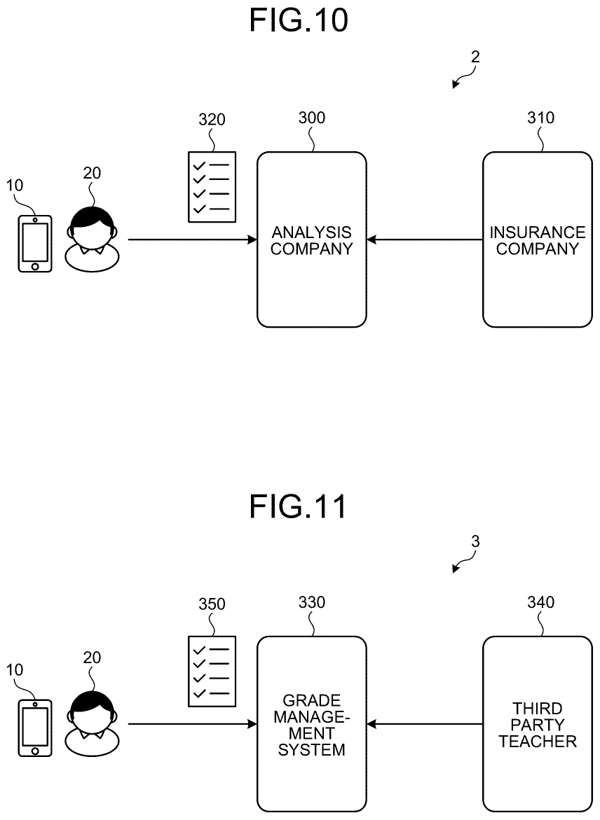

Next, a case where the information processing according to the embodiment is applied will be described. FIG. 10 is a diagram (1) illustrating an application example of the information processing according to the present disclosure.

An information processing system 2 illustrated in FIG. 10 includes an analysis company 300 and an insurance company 310. In the example of FIG. 10, the analysis company 300 corresponds to the management system 100, and the insurance company 310 corresponds to the data requester 200. For example, the analysis company 300 is a company that manages biometric data collected from the user terminal 10 that is a wearable device used by the user 20. Furthermore, the insurance company 310 is a company that desires statistical data regarding health of a user.

In the example illustrated in FIG. 10, it is assumed that the user 20 consents to provide user information in a contract 320 issued by the analysis company 300. Here, when the insurance company 310 requests statistical data regarding health of about 1000 users, the analysis company 300 applies the information processing according to the embodiment, and proves that there is a consent to the privacy policy (i.e., provision of user information) for 1000 users. Then, the analysis company 300 verifies that there is a consent on the blockchain 50 using the created proof, and then provides data for 1000 people to the insurance company 310.

As described above, the analysis company 300 can provide the user information for the 1000 persons to the insurance company 310 without disclosing the contents of the consent information for the 1000 persons to the outside and after verifying that the consents have been correctly obtained from the users.

In the example of FIG. 10, the analysis company 300 can quickly provide data to the insurance company 310 by performing verification using, for example, the algorithm illustrated in FIG. 5. Furthermore, the analysis company 300 can also perform verification using the algorithm illustrated in FIG. 8 or 9. For example, in a case where the number of users designated by the insurance company 310 accounts for most of all registrants related to the contract 320, the analysis company 300 can perform processing at a high speed particularly by using the algorithm illustrated in FIG. 9.

Next, a case where information processing according to a modification is applied will be described. FIG. 11 is a diagram (2) illustrating an application example of the information processing according to the present disclosure.

An information processing system 3 illustrated in FIG. 11 includes a grade management system 330 and a third party teacher 340. In the example of FIG. 11, the grade management system 330 corresponds to the management system 100, and the third party teacher 340 corresponds to the data requester 200. For example, the grade management system 330 is an organization that manages grade data of about 100,000 students (e.g., a total number of students of one year in an arbitrary region). In addition, it is assumed that the third party teacher 340 desires statistical data calculated from grades of all students.

In the example illustrated in FIG. 11, the user 20 who is a student consents to provide grade data in a contract 350 issued by the grade management system 330. Here, assuming that the third party teacher 340 requests provision of the grade data of all the students, the grade management system 330 applies the information processing according to the embodiment and proves that there is a consent to the privacy policy for the data of all the students. Then, after verifying that there is a consent on the blockchain 50, the grade management system 330 provides the data of all the students to the third party teacher 340.

In the example of FIG. 11, the grade management system 330 performs verification particularly using the algorithm illustrated in FIG. 5, and thus, even if the data is related to a relatively large number of users, it is possible to quickly verify the consent information by collectively creating proofs. Therefore, it is possible to extremely quickly provide the data to the third party teacher 340.

### 2. Other Embodiments

The processing according to each embodiment described above may be performed in various different modes other than each embodiment described above.

For example, in the above-described embodiment, the example has been described in which the user terminal 10 converts information so as to conceal (hash) the consent information or the like on the basis of the content input to the contract by the user 20, and writes the converted information to the blockchain 50. However, such conversion may be executed by the management system 100. For example, when acquiring the content input to the contract by the user 20, the management system 100 converts the information so as to conceal the consent information or the like, and writes the converted information to the blockchain 50. In this case, the control unit 130 of the management system 100 includes a conversion unit in addition to the configuration illustrated in FIG. 3. Specifically, when writing, to the blockchain 50, a trace indicating that a user has consented in advance to provide the user information to a third party, the conversion unit converts the trace to be concealed, acquires a converted secret value, and writes a public value to be paired with the secret value to the blockchain 50. In this case, the above-described verification unit 134 verifies the consents of the plurality of users using a secret value acquired by the conversion unit and a public value to be paired with the secret value. As a result, it is not necessary for the user terminal 10 to perform the conversion processing, and thus, the processing on the user side is reduced.

Among the processing described in the above embodiments, it is possible to manually perform all or a part of the processing described as being performed automatically, or it is possible to automatically perform, by a known method, all or a part of the processing described as being performed manually. In addition, the processing procedures, the specific names, and the information including various data and parameters illustrated in the above document and drawings can be arbitrarily changed unless otherwise specified. For example, the various types of information illustrated in the respective drawings are not limited to the illustrated information.

In addition, each component of each device illustrated in the drawings is functionally conceptual, and is not necessarily configured physically as illustrated in the drawings. Specifically, a specific form of distribution and integration of each device is not limited to the illustrated form, and all or a part thereof can be functionally or physically distributed and integrated on an arbitrary unit basis according to various loads, use conditions, and the like.

In addition, the above-described embodiments and modifications can be appropriately combined within a range in which the processing contents do not contradict each other.

Furthermore, the effects described in the present specification are examples only and are not limited, and other effects may be provided.

### 3. Effects of Information Processing Device According to Present Disclosure

As described above, the information processing device (the management system 100 in the embodiment) according to the present disclosure has the reception unit (the reception unit 133 in the embodiment) and the verification unit (the verification unit 134 in the embodiment). The reception unit receives a request related to provision of user information which is information collected from a user, the request being for a plurality of pieces of user information collected from a plurality of users. In a case where the request is received by the reception unit, the verification unit verifies consents of the plurality of users by executing a procedure for collectively proving that a consent has been obtained from each user who is a collection source of the plurality of pieces of user information on the blockchain in which a trace indicating that a user has consented in advance to the provision of the user information to a third party is registered.

As described above, utilizing the characteristics of the blockchain in which registered information cannot be falsified, the information processing device according to the present disclosure verifies a consent of a user on the basis of the fact that consent information has been registered in the blockchain. Furthermore, the information processing device can complete verification at high speed by collectively executing verification of consent information related to a plurality of users. This enables the information processing device to utilize the user information at high speed without disclosing to the outside whether or not the user has consented to use the user information.

In addition, the verification unit verifies consents of a plurality of users by executing a procedure for proving that a secret value used in conversion processing for concealment has been acquired on the blockchain in which a concealed trace is registered. Specifically, the verification unit verifies consents of a plurality of users by executing a procedure for proving that a secret value used in conversion processing for hashing has been acquired on the blockchain in which a hashed trace is registered.

As described above, the information processing device registers the concealed information in the blockchain and uses the information for verification, so that it is possible to reliably verify that the consent has been obtained while holding the content consented by the user in a form invisible to the outside.

The verification unit verifies the consents of the plurality of users by verifying that a trace is registered on the blockchain using a smart contract that verifies a proof on the blockchain.

As described above, the information processing device can perform the verification processing utilizing the characteristics of the blockchain by using the smart contract in the blockchain.

In addition, the verification unit acquires a secret value issued when a user has registered in the blockchain, creates a proof by collating a value obtained by collecting acquired secret values of a plurality of users with a value obtained by collecting public values written by a plurality of users in the blockchain, and verifies the proof on the blockchain, thereby verifying consents of the plurality of users. Specifically, the verification unit creates a proof by collating the total value of the secret values acquired from the plurality of users with the total value of the public values written from the plurality of users in the blockchain and verifies the proof on the blockchain, thereby verifying consents of the plurality of users.

As described above, since the information processing device performs the processing using the total value of the secret values at the time of concealment and the total value of the public values written in the blockchain, thereby reducing the number of times of arithmetic processing related to creation and verification of a proof, the processing can be performed quickly.

In addition, the information processing device further includes the conversion unit. When writing, to the blockchain, a trace indicating that a user has consented in advance to provide the user information to a third party, the conversion unit converts the trace so as to be concealed, acquires a converted secret value, and writes a public value to be paired with the secret value to the blockchain. The verification unit verifies the consents of the plurality of users using the secret value acquired by the conversion unit and the public value to be paired with the secret value.

As described above, by performing concealment processing, the information processing device can execute the information processing according to the embodiment without putting a load on the user terminal side.

In addition, the information processing device further includes a transmission unit. In a case where the verification unit verifies consents of a plurality of users, the transmission unit transmits user information related to the users whose consents have been verified to request sources of the plurality of pieces of user information.

As described above, by transmitting the verified user information to the request source, the information processing device can reliably provide only the user information for which the consent is certainly made to the request source.

### 4. Hardware Configuration

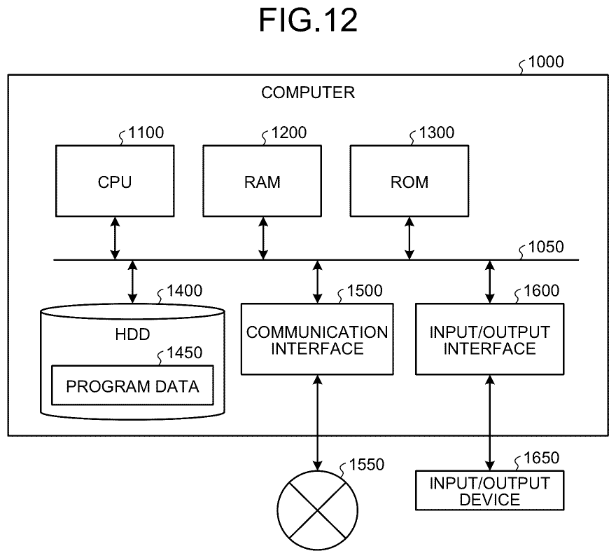

The information apparatuses such as the management system 100 and the user terminal 10 according to the embodiments described above are realized by a computer 1000 having a configuration as illustrated in FIG. 12, for example. In the following, the management system 100 according to the embodiment will be described as an example. FIG. 12 is a hardware configuration diagram illustrating an example of the computer 1000 that implements the functions of the management system 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 into the RAM 1200, and executes processing corresponding to various programs.

The ROM 1300 stores a boot program such as a basic input output system (BIOS) executed by the CPU 1100 when the computer 1000 is activated, a program depending on the hardware of the computer 1000, and the like.

The HDD 1400 is a computer-readable recording medium that non-transiently records a program executed by the CPU 1100, data used by the program, and the like. Specifically, the HDD 1400 is a recording medium that records the information processing program according to the present disclosure as an example of program data 1450.

The communication interface 1500 is an interface for the computer 1000 to connect to an external network 1550 (e.g., the Internet). For example, the CPU 1100 receives data from other apparatus or transmits data generated by the CPU 1100 to other apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the management system 100 according to the embodiment, the CPU 1100 of the computer 1000 implements the functions of the control unit 130 and the like by executing the information processing program loaded on the RAM 1200. In addition, the HDD 1400 stores the information processing program according to the present disclosure and data in the storage unit 120. Note that although the CPU 1100 reads the program data 1450 from the HDD 1400 and executes the program data, as another example, programs may be acquired from other device via the external network 1550.

Note that the present technique can also have the following configurations.

(1) An information processing device comprising:
a reception unit that receives a request regarding provision of user information that is information collected from a user, the request being for a plurality of pieces of user information collected from a plurality of users; and
a verification unit that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.
   (2) The information processing device according to (1), wherein
on the blockchain in which the trace concealed is registered, the verification unit verifies the consents of the plurality of users by executing a procedure for proving that a secret value used in conversion processing for the concealment has been acquired.
   (3) The information processing device according to (2), wherein
on the blockchain in which the trace hashed is registered, the verification unit verifies the consents of the plurality of users by executing a procedure for proving that a secret value used in conversion processing for the hashing has been acquired.
   (4) The information processing device according to any one of (1) to (3), wherein
the verification unit verifies the consents of the plurality of users by verifying that the trace is registered on the blockchain using a smart contract that verifies the proof on the blockchain.
   (5) The information processing device according to (4), wherein
the verification unit verifies the consents of the plurality of users by acquiring secret values issued when the users have registered in the blockchain, creating the proof by collating a value obtained by collecting the acquired secret values of the plurality of users with a value obtained by collecting public values written by the plurality of users in the blockchain, and verifying the proof on the blockchain.
   (6) The information processing device according to (5), wherein
the verification unit verifies the consents of the plurality of users by creating the proof by collating a total value of the secret values acquired from the plurality of users with a total value of the public values written by the plurality of users in the blockchain, and verifying the proof on the blockchain.
   (7) The information processing device according to (4) or (5), further comprising:
a conversion unit that converts a trace to be concealed when writing the trace in the blockchain, the trace indicating that the user has consented in advance to provide the user information to a third party, acquires the converted secret value, and writes a public value to be paired with the secret value to the blockchain, wherein
the verification unit verifies the consents of the plurality of users by using the secret value acquired by the conversion unit and the public value to be paired with the secret value.
   (8) The information processing device according to any one of (1) to (7), further comprising:
a transmission unit that in a case where the verification unit verifies the consents of the plurality of users, transmits the user information related to the users whose consents have been verified to request sources of the plurality of pieces of user information.
   (9) An information processing method wherein
a computer:
receives a request regarding provision of user information that is information collected from a user, the request being for a plurality of pieces of user information collected from a plurality of users; and
in a case where the request is received, verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered.
   (10) A computer program product, including an information processing program for causing a computer to function as:
a reception unit that receives a request regarding provision of user information that is information collected from a user, the request being for a plurality of pieces of user information collected from a plurality of users; and
a verification unit that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.

### REFERENCE SIGNS LIST

1 INFORMATION PROCESSING SYSTEM
10 USER TERMINAL
20 USER
30 CONTRACT
50 BLOCKCHAIN
100 MANAGEMENT SYSTEM
110 COMMUNICATION UNIT
120 STORAGE UNIT
121 CONSENT INFORMATION STORAGE UNIT
130 CONTROL UNIT
131 ISSUANCE UNIT
132 ACQUISITION UNIT
133 RECEPTION UNIT
134 VERIFICATION UNIT
135 TRANSMISSION UNIT
200 DATA REQUESTER

1. An information processing device comprising:
a reception unit that receives a request regarding provision of user information that is information collected from a user, the request being for a plurality of pieces of user information collected from a plurality of users; and
a verification unit that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.

2. The information processing device according to claim 1, wherein
on the blockchain in which the trace concealed is registered, the verification unit verifies the consents of the plurality of users by executing a procedure for proving that a secret value used in conversion processing for the concealment has been acquired.

3. The information processing device according to claim 2, wherein
on the blockchain in which the trace hashed is registered, the verification unit verifies the consents of the plurality of users by executing a procedure for proving that a secret value used in conversion processing for the hashing has been acquired.

4. The information processing device according to claim 1, wherein
the verification unit verifies the consents of the plurality of users by verifying that the trace is registered on the blockchain using a smart contract that verifies the proof on the blockchain.

5. The information processing device according to claim 4, wherein
the verification unit verifies the consents of the plurality of users by acquiring secret values issued when the users have registered in the blockchain, creating the proof by collating a value obtained by collecting the acquired secret values of the plurality of users with a value obtained by collecting public values written by the plurality of users in the blockchain, and verifying the proof on the blockchain.

6. The information processing device according to claim 5, wherein
the verification unit verifies the consents of the plurality of users by creating the proof by collating a total value of the secret values acquired from the plurality of users with a total value of the public values written by the plurality of users in the blockchain, and verifying the proof on the blockchain.

7. The information processing device according to claim 4, further comprising:
a conversion unit that converts a trace to be concealed when writing the trace in the blockchain, the trace indicating that the user has consented in advance to provide the user information to a third party, acquires the converted secret value, and writes a public value to be paired with the secret value to the blockchain, wherein
the verification unit verifies the consents of the plurality of users by using the secret value acquired by the conversion unit and the public value to be paired with the secret value.

8. The information processing device according to claim 1, further comprising:
a transmission unit that in a case where the verification unit verifies the consents of the plurality of users, transmits the user information related to the users whose consents have been verified to request sources of the plurality of pieces of user information.

9. An information processing method wherein
a computer:
receives a request regarding provision of user information that is information collected from a user, the request being for a plurality of pieces of user information collected from a plurality of users; and
in a case where the request is received, verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered.

10. A computer program product, including an information processing program for causing a computer to function as:
a reception unit that receives a request regarding provision of user information that is information collected from a user, the request being for a plurality of pieces of user information collected from a plurality of users; and
a verification unit that verifies consents of the plurality of users by executing a procedure for collectively proving that a consent has been obtained from each user who is a collection source of the plurality of pieces of user information on a blockchain in which a trace indicating that the user has consented in advance to provision of the user information to a third party is registered in a case where the request is received by the reception unit.
